(19) United States
(12) Patent Application Publication
(10) Pub. No.: US 2025/0353467 A1
(43) Pub. Date: Nov. 20, 2025

(54) VEHICLE WIPER DEVICE

(71) Applicant: TOYOTA JIDOSHA KABUSHIKI KAISHA, Toyota-shi (JP)

(72) Inventors: Akira MATSUURA, Toyota-shi (JP); Keiichi Oka, Seto-shi (JP)

(73) Assignee: TOYOTA JIDOSHA KABUSHIKI KAISHA, Toyota-shi (JP)

(21) Appl. No.: 19/038,898

(22) Filed: Jan. 28, 2025

(30) Foreign Application Priority Data
May 14, 2024 (JP) 2024-078667

(51) Int. Cl. B60S 1/34; B60S 1/06

(52) U.S. Cl. CPC B60S 1/3431; B60S 1/06

(57) ABSTRACT

In a vehicle wiper device having a wiper arm rotatably supported by a vehicle body and a wiper blade supported by the wiper arm, the wiper arm includes a link mechanism of 4 nodes, a fulcrum located closer to the wiper blade in the link mechanism is located on a side opposite to the wiper blade than a position of a hinge of the wiper arm, and when the wiper blade is at a lower end of a windshield, an arm connected to a drive shaft of each arm constituting the link mechanism is disposed below the drive shaft, and a rotation direction of the drive shaft and a rotation direction of the wiper arm are the same direction.

### CROSS-REFERENCE TO RELATED APPLICATION

This application claims priority to Japanese Patent Application No. 2024-078667 filed on May 14, 2024, incorporated herein by reference in its entirety.

### BACKGROUND

### 1. Technical Field

The present disclosure relates to a vehicle wiper device.

### 2. Description of Related Art

Various types of wiper devices mounted on vehicles have been proposed. For example, Japanese Unexamined Patent Application Publication No. 2011-168165 (JP 2011-168165 A) discloses a wiper device including one wiper arm, the wiper arm being constituted by a link mechanism. Japanese Unexamined Patent Application Publication No. 2004-142499 (JP 2004-142499 A) discloses a wiper device including two wiper arms and a link mechanism provided on only one of the wiper arms.

Specifically, the wiper device disclosed in JP 2011-168165 A includes a main arm a and a sub arm b, as illustrated in FIG. 4A. A connecting arm d is rotatably connected between a distal end portion of the main arm a closer to a wiper blade c and a distal end portion of the sub arm b closer to the wiper blade c.

On the other hand, the wiper device disclosed in JP 2004-142499 A includes two wiper arm e and f, as illustrated in FIG. 4B. By providing a link mechanism g at the proximal end portion of one wiper arm f, the wiping area can be increased only for the region to be wiped by the wiper arm f. The link mechanism g is a link with four nodes, including an arm head i, a main lever k, and a sub lever n. The arm head i is connected to a retainer h of the wiper arm f. One end of the main lever k is connected to a pivot shaft j, and the other end of the main lever k is connected to the arm head i. The sub lever n is disposed at a position spaced apart from the pivot shaft j by a predetermined distance. One end of the sub lever n is connected to a driven shaft m, and the other end of the sub lever n is connected to the arm head i.

### SUMMARY

In recent years, a vehicle in which the inclination angle of a front windshield is set to be small in consideration of aerodynamic characteristics and design properties of the vehicle has become popular. In this case, the length dimension of the front windshield in the longitudinal direction (vehicle body front-rear direction) tends to increase, and a means for increasing the wiping area to the upper portion of the front windshield is required.

As a means for increasing the wiping area for the front windshield having a long length dimension in the longitudinal direction, it is conceivable to provide a wiper device including two wiper arms, in which the length of a wiper blade on the driver's seat side is increased, for example. In this case, however, the area of an overlapping portion between the region to be wiped by the wiper blade on the driver's seat side and the region to be wiped by a wiper blade on the passenger's seat side increases, which leads to deterioration in wiping efficiency.

In the configuration in which only one wiper arm is provided as in the wiper device disclosed in JP 2011-168165 A (the one illustrated in FIG. 4A), there is no overlapping portion in the first place, and therefore the above issue can be addressed. However, the link mechanism of the wiper device disclosed in JP 2011-168165 A is intended to bring the wiper blade c closer to being parallel to a vertical frame p of a front windshield o at the upper reversing position. Therefore, it does not contribute to increasing the wiping area. The upper reversing position is a rotation position at which the wiper blade c extends along the vertical frame p of the front windshield o.

On the other hand, when the length of the wiper blade on the driver's seat side is set to be long, the area of the overlapping portion can be reduced by setting the length of the wiper blade on the passenger's seat side to be short. In this case, however, a large unwiped region remains at the upper portion of the front windshield on the passenger's seat side.

It is possible to reduce this unwiped region by providing the link mechanism g at the proximal end portion of one wiper arm f as in the wiper device disclosed in JP 2004-142499 A (the one illustrated in FIG. 4B). However, the wiper device disclosed in JP 2004-142499 A has a configuration in which only one wiper arm f is provided with the link mechanism g. Therefore, it is not intended to increase the wiping area for the entire front windshield o using only one wiper arm. That is, the wiper device disclosed in JP 2004-142499 A is a technique assuming a wiper device including two wiper arm e and f.

As described above, there has been no proposal to increase the wiping area for the entire front windshield in a wiper device including only one wiper arm capable of reducing the number of parts. Also, in a wiper device provided for a rear windshield, there has been no proposal to increase the wiping area for the entire rear windshield with only one wiper arm.

The present disclosure provides a vehicle wiper device including only one wiper arm and capable of increasing the wiping area for the entire windshield.

A first aspect of the present disclosure provides

a vehicle wiper device including a wiper arm rotatably supported by a vehicle body and a wiper blade supported by the wiper arm, in which:
the wiper arm includes a link mechanism with four nodes, a fulcrum located near the wiper blade in the link mechanism being located on an opposite side of the wiper blade from a position of a hinge of the wiper arm;
when the wiper blade is at a lower end of a windshield, an arm connected to a drive shaft, among arms constituting the link mechanism, is disposed below the drive shaft; and
a rotation direction of the drive shaft and a rotation direction of the wiper arm are the same direction.

According to the first aspect, during reciprocal turning operation of the wiper arm, the wiper blade is pushed toward the outer region (in particular, the upper region) of the windshield by the operation of the link mechanism with four nodes. That is, the movement locus of the outer end of the wiper blade is shifted toward the upper region of the windshield. As a result, the wiping area in the upper region of the windshield can be increased. That is, in the wiper device including only one wiper arm, it is possible to increase the wiping area for the entire windshield (in particular, the upper region).

A second aspect of the present disclosure provides

a vehicle wiper device including a wiper arm rotatably supported by a vehicle body and a wiper blade provided on the wiper arm, in which:
the wiper arm includes a link mechanism with four nodes, a fulcrum located near the wiper blade in the link mechanism being located on a power input fulcrum side in the link mechanism from a position of a hinge of the wiper arm;
when the wiper blade is at a lower end of a windshield, an arm connected to a drive shaft, among arms constituting the link mechanism, is disposed below the drive shaft; and
a rotation direction of the drive shaft and a rotation direction of the wiper arm are the same direction.

According to the second aspect, similarly to the first aspect, it is possible to increase the wiping area for the entire windshield in the wiper device including only one wiper arm.

In the first aspect and the second aspect,

the link mechanism may include a main arm extending in a direction along a vehicle width direction in a state in which the wiper blade is at the lower end of the windshield, a sub arm extending in the direction along the vehicle width direction on an upper side of the main arm, and a wiper arm head connected between the main arm and the sub arm and to which the wiper blade is connected via a wiper arm body;
the drive shaft may be connected to the main arm, and the link mechanism may operate such that power from the drive shaft is received by the main arm and causes the wiper blade to perform reciprocal turning operation; and
an angle between an extending direction of the main arm and an extending direction of the wiper arm head and an angle between an extending direction of the sub arm and the extending direction of the wiper arm head may change as the wiper blade moves from a state in which the wiper blade is at the lower end of the windshield to a state in which the wiper blade is at a lateral end of the windshield, increasing a distance between a connecting position between the sub arm and the wiper arm head and a position of the drive shaft.

In this manner, as the wiper blade moves from the state in which the wiper blade is at the lower end of the windshield toward the state in which the wiper blade is at the lateral end of the windshield, the respective angles change. This increases the distance between the connecting position between the sub arm and the wiper arm head and the position of the drive shaft increases. As a result, the movement locus of the outer end of the wiper blade connected to the wiper arm head via the wiper arm body is shifted toward the upper region of the windshield. Accordingly, it is possible to implement a configuration of the link mechanism capable of increasing the wiping area for the entire windshield.

Further, in the first aspect and the second aspect,

a turning angle of the drive shaft during turning of the wiper blade from a state in which the wiper blade is at the lower end of the windshield to a state in which the wiper blade is at a lateral end of the windshield may be in a predetermined range of 150° or more.

In the present disclosure, in a wiper device including one wiper arm, the wiper arm includes a link mechanism with four nodes. The wiper blade is pushed toward the upper region of the windshield by the operation of the link mechanism during turning operation. Accordingly, the wiping area in the upper region of the windshield can be increased. Therefore, it is possible to increase the wiping area for the entire front windshield with the wiper device including only one wiper arm capable of reducing the number of parts.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a view illustrating a wiper device according to an embodiment, and is a front view illustrating a wiper device together with a windshield;

FIG. 1B is a view illustrating a wiper device according to the embodiment, in which a link mechanism of the wiper device is enlarged;

FIG. 1C is a cross-sectional view taken along IC-IC line in FIG. 1B;

FIG. 2A is a diagram for explaining a wiping operation of a wiper device according to the embodiment;

FIG. 2B is a diagram for explaining a wiping operation of a wiper device according to the embodiment;

FIG. 2C is a diagram for explaining a wiping operation of a wiper device according to the embodiment;

FIG. 3 shows the results of an experiment conducted to compare a plurality of comparative examples with the present disclosure;

FIG. 4A is a front view of a wiper device with a windshield according to the related art; and

FIG. 4B is a front view of a wiper device according to the related art together with a windshield.

### DETAILED DESCRIPTION OF EMBODIMENTS

Hereinafter, embodiments of the present disclosure will be described with reference to the drawings. In the present embodiment, a case where the present disclosure is applied as a wiper device for wiping a windshield will be described.

### Configuration of Wiper Device

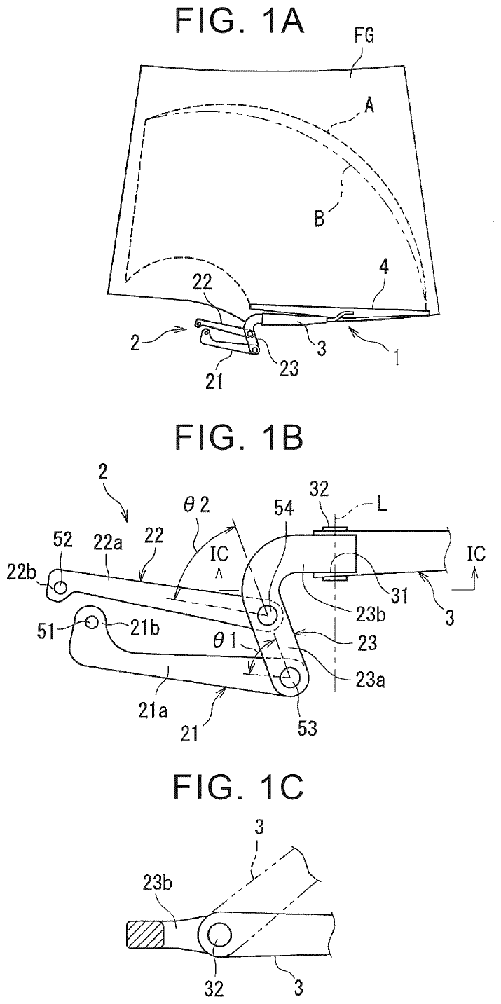

FIG. 1A is a front view showing a wiper device 1 according to the present embodiment together with a windshield FG of the wiper device 1. FIG. 1B is a diagram showing the wiper device 1 according to the present embodiment, and is a diagram showing an enlarged view of the link mechanism 2 of the wiper device 1. FIG. 1C is a cross-sectional view taken along IC-IC line in FIG. 1B.

As shown in FIGS. 1A to 1C, the wiper device 1 according to the present embodiment wipes rainwater, snow, and the like adhering to a windshield FG of a vehicle. The wiper device 1 includes a wiper motor (not shown), a link mechanism 2 and a wiper arm body 3 constituting the wiper arm, and a wiper blade 4.

The wiper motor is a power source of the wiper device 1 and is attached to a body (cowl portion) of the vehicle. The wiper motor is connected to an output shaft (drive shaft) 51 (refer to FIG. 1B) via a known converter for converting a continuous rotational movement into a reciprocating rotational movement. The wiper arm body 3 performs a reciprocating rotation operation by the reciprocating rotational movement of the output shaft 51 accompanying the operation of the wiper motor. Since the wiper arm body 3 rotates integrally with the wiper blade 4, in the following, this rotation may be referred to as a rotation of the wiper arm body 3 or a rotation of the wiper blade 4. Further, there is also a case where the wiper device 1 is simply referred to as a rotation.

The link mechanism 2 includes a main arm 21, a sub arm 22, and a wiper arm head 23.

The arrangement positions of the main arm 21, the sub arm 22, and the wiper arm head 23 are as follows. That is, as shown in FIG. 1A, when the wiper device 1 is in the lower reversing position, the main arm 21 is positioned below the sub arm 22. The wiper arm head 23 is located on the wiper arm body 3 side (right side in FIG. 1A) with respect to each of the main arm 21 and the sub arm 22. The lower reversing position is a position in which the wiper device 1 is in an attitude along the lower end of the windshield FG. The state in which the wiper device 1 is in the lower reversing position is a state in which the wiper blade is at the lower end of the windshield in the present disclosure.

The main arm 21 is formed of a substantially L-shaped member extending in a direction substantially along the vehicle width direction in the state of being in the lower reversing position. Specifically, the main arm 21 includes an arm main body portion 21a having a predetermined length and a support portion 21b that is continuous with the arm main body portion 21a and bent in a direction substantially perpendicular to the extending direction of the arm main body portion 21a. An output shaft 51 is connected to a central portion of the support portion 21b, and a rotational force from the wiper motor is transmitted from the support portion 21b to the link mechanism 2.

Further, in the lower reversed position shown in FIG. 1B, the support portion 21b continues to a side (left side in FIG. 1B) of the arm main body portion 21a opposite to the wiper arm body 3 side. In addition, the support portion 21b extends upward with a relatively short dimension from a portion that is contiguous with the arm main body portion 21a. Further, as the attitude of the arm main body portion 21a in the lower reversing position shown in FIG. 1B, it is slightly inclined downward toward the wiper arm body 3 side (right side in FIG. 1B) from a portion which is contiguous to the support portion 21b . The position of the arm main body portion 21a is one example of “the arm connected to the drive shaft among the arms constituting the link mechanism is disposed below the drive shaft”.

The sub arm 22 is also formed of a substantially L-shaped member extending in a direction substantially along the vehicle width direction in the state of being in the lower reversing position. Specifically, the sub arm 22 also includes an arm main body portion 22a having a predetermined length and a support portion 22b that is continuous with the arm main body portion 22a and bent in a direction substantially perpendicular to the extending direction of the arm main body portion 22a. A sub-shaft 52 attached to the body of the vehicle is connected to a central portion of the support portion 22b, and the sub arm 22 is rotatable about the sub-shaft 52.

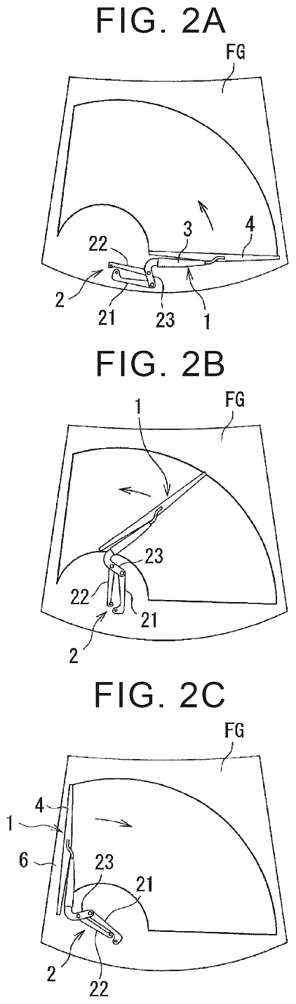

Further, the position of the sub-shaft 52 is set at a position at a predetermined distance from the upper side of the output shaft 51 and at a position opposite to the wiper arm body 3 side (the left side in FIG. 1B). The position of the sub-shaft 52 is set to a position at which the distance between the output shaft 51 and the sub-shaft 52 can be shortened as much as possible within a range in which the main arm 21 and the sub arm 22 do not interfere with each other when the wiper device 1 rotates from the lower reversing position toward the upper reversing position. Thus, the size of the link mechanism 2 is reduced. The upside-down position is a position in which the wiper device 1 is in a position along the vertical frame 6 of the windshield FG (see FIG. 2C).

Further, in the lower reversed position shown in FIG. 1B, the support portion 22b continues to a side (left side in FIG. 1B) of the arm main body portion 22a opposite to the wiper arm body 3 side. Further, the support portion 22b extends downward with a relatively short dimension from a portion that is contiguous with the arm main body portion 22a. Further, as the attitude of the arm main body portion 22a in the lower reversing position shown in FIG. 1B, it is slightly inclined downward toward the wiper arm body 3 side (right side in FIG. 1B) from a portion which is contiguous to the support portion 22b.

The wiper arm head 23 is formed of a substantially L-shaped member that connects the main arm 21, the sub arm 22, and the wiper arm body 3. Specifically, the wiper arm head 23 includes a first arm head portion 23a and a second arm head portion 23b that is contiguous to the first arm head portion 23a.

The first arm head portion 23a is connected to the main arm 21 and the sub arm 22. That is, the vicinity of the longitudinal end portion of the first arm head portion 23a is rotatably connected to the distal end portion of the main arm 21 (the arm main body portion 21a) by the connecting shaft 53. In the lower reversed position shown in FIG. 1B, the vicinity of the lower end portion of the first arm head portion 23a is rotatably connected to the right end portion of the main arm 21 by the connecting shaft 53. Further, the other side of the first arm head portion 23a in the longitudinal direction is rotatably connected to the distal end portion of the sub arm 22 (the arm main body portion 22a) by the connecting shaft 54. In the lower reversed position shown in FIG. 1B, the upper part of the first arm head portion 23a is rotatably connected to the right end of the sub arm 22 by the connecting shaft 54.

With such a configuration, the space between the output shaft 51 and the sub-shaft 52 can be regarded as one link arm. Therefore, the link arm, the main arm 21, the sub arm 22, and the first arm head portion 23a of the wiper arm head 23 constitute the link mechanism 2 of four nodes.

The second arm head portion 23b is a portion that transmits the rotational force of the link mechanism 2 to the wiper arm body 3. The second arm head portion 23b extends horizontally (rightward in FIG. 1B) and continuously to the upper part of the first arm head portion 23a in the downward reversed position shown in FIG. 1B. The second arm head portion 23b supports the wiper arm body 3 so as to be rotatable in contact with and away from the windshield FG (see a state indicated by a solid line in FIG. 1C and a state indicated by an imaginary line). With the distal end portion of the second arm head portion 23b disposed inside the concave portion 31 provided at the proximal end portion of the wiper arm body 3, the support pin 32 is inserted through the proximal end portion of the wiper arm body 3 and the distal end portion of the second arm head portion 23b. Thus, the wiper arm body 3 is configured to be rotatable about the axis L of the support pin 32. That is, the support pin 32 constitutes a hinge that allows the wiper arm body 3 to rotate.

A central portion of the wiper blade 4 in the longitudinal direction is supported by the wiper arm body 3. In the wiper blade 4, a wiper rubber (not shown) is attached to a side facing the front windshield FG. Further, the wiper blade 4 is pressed toward the front windshield FG together with the wiper rubber by a wiper spring (not shown) incorporated in the wiper arm body 3.

As a characteristic of the present embodiment, in the lower reversed position shown in FIGS. 1A to 1C, the positions of the connecting shafts 53 and 54 are positioned on the other side of the wiper blade 4 than the position of the axis L of the support pin 32. In other words, in the state of the lower reversing position, the positions of the connecting shafts 53 and 54 are located closer to the output shaft 51 (the power input fulcrum side) than the position of the axis L of the support pin 32. That is, the positions of the connecting shafts 53 and 54 in the condition shown in FIG. 1A are located on the left side of the position of the axis L of the support pin 32. Therefore, each of the connecting shafts 53 and 54 is an example of a “fulcrum located near the wiper blade in the link mechanism” of the present disclosure. Further, the fact that the positions of the connecting shafts 53 and 54 are defined in this way is an example of “the fulcrum located closer to the wiper blade in the link mechanism is located on the side opposite to the wiper blade than the hinge position of the wiper arm” of the present disclosure. Further, the fact that the positions of the connecting shafts 53 and 54 are defined in this way is an example of “the fulcrum located closer to the wiper blade in the link mechanism is located closer to the power input fulcrum side in the link mechanism than the hinge position of the wiper arm”.

In the lower reversed position shown in FIGS. 1A to IC, the position of the connecting shaft 54 is set at a position at which a predetermined distance is provided from the connecting shaft 53, and at a position at which a predetermined distance is provided from the wiper arm body 3 (the left side in FIG. 1B). Accordingly, an angle formed between the extending direction of the arm main body portion 21a in the main arm 21 and the extending direction of the first arm head portion 23a in the wiper arm head 23 is an angle θ1 shown in FIG. 1B. Further, an angle formed between the extending direction of the arm main body portion 22a in the sub arm 22 and the extending direction of the first arm head portion 23a in the wiper arm head 23 is an angle θ2 shown in FIG. 1B. These angles θ1 and θ2 increase as the wiper device 1 rotates from the lower reversing position toward the upper reversing position (refer to FIGS. 2A to 2C showing the wiping operation of the wiper device 1). As the angles θ1 and θ2 increase, the distance between the output shaft 51 and the connecting shaft 54 increases. Due to a change in the attitude of the wiper arm head 23 with respect to the respective arms 21 and 22, the wiper arm body 3 and the wiper blade 4 are pushed out toward the upper area of the windshield FG. That is, the outer end of the wiper blade 4 moves away from the output shaft 51. The two-dot chain line B in FIG. 1A is a moving locus of the outer end of the wiper blade 4 when the output shaft 51 is set as the rotation center, assuming that the link mechanism 2 is not provided. The broken line A in FIG. 1A is a moving locus of the outer end of the wiper blade 4 caused by the fact that the wiper arm body 3 and the wiper blade 4 are pushed out toward the upper area of the windshield FG by providing the link mechanism 2. As described above, by providing the link mechanism 2, the wiping area of the upper area of the windshield FG can be increased. Wiping operation of wiper device

Next, a wiping operation of the wiper device 1 configured as described above will be described. FIGS. 2A to 2C are each a diagram illustrating a wiping operation of the wiper device 1. As shown in FIG. 2A, the wiper motor is operated from the position where the wiper device 1 is in the lower reversing position. With this operation, the output shaft 51 (see FIG. 1B) rotates (rotates counterclockwise in the drawing). This rotational force is transmitted to the wiper arm body 3 via the link mechanism 2. Then, as indicated by an arrow in FIG. 2A, the windshield FG is wiped by the wiper rubber attached to the wiper blade 4 while the wiper arm body 3 is rotated toward the upside-down position. That is, the rotation direction of the output shaft 51 and the rotation direction of the wiper arm body 3 and the wiper blade 4 are the same direction, and the windshield FG is wiped off.

In a situation where the wiper arm body 3 rotates toward the upper reversing position, the angle θ1 and the angle θ2 increase from the positional relationship between the shafts 51, 52, 53, and 54 connected to the main arm 21 and the sub arm 22, respectively. The angle θ1 is an angle formed between the extending direction of the arm main body portion 21a in the main arm 21 and the extending direction of the first arm head portion 23a in the wiper arm head 23. The angle θ2 is an angle formed between the extending direction of the arm main body portion 22a in the sub arm 22 and the extending direction of the first arm head portion 23a in the wiper arm head 23. That is, the first arm head portion 23a of the wiper arm head 23 rotates relative to the main arm 21 with the connecting shaft 53 as a rotation center (rotates clockwise in the drawing). As a result, the position of the connecting shaft 54 moves away from the output shaft 51. This increases the distance between the output shaft 51 and the connecting shaft 54. Accordingly, the wiper arm body 3 and the wiper blade 4 are pushed toward the upper area of the windshield FG (the outer end of the wiper blade 4 moves away from the output shaft 51). As a result, the movement locus of the outer end of the wiper blade 4 is shifted outward (upward) as compared with the movement locus of the outer end of the wiper blade 4 (the two-dot chain line B in FIG. 1A) assuming that the link mechanism 2 is not provided (the broken line A in FIG. 1A). As a consequence, the wiping area of the upper area of the windshield FG can be enlarged.

Further, as shown in FIG. 2C, when the wiper device 1 reaches the upside-down position, the respective angles θ1 and θ2 are maximized (maximized in the variation of the respective angles θ1 and θ2). That is, the relative displacement of the wiper blade 4 in the extending direction in the clockwise direction in FIG. 2C with respect to the extending direction of the main arm 21 and the sub arm 22 increases. The extending direction of the wiper blade 4 substantially coincides with the extending direction of the vertical frame 6 of the windshield FG. In this way, the wiper blade 4 is brought into a rotational position along the vertical frame 6 of the windshield FG, and it is possible to prevent the wiping remaining area from being generated around the vertical frame 6.

When the wiper device 1 rotates from the upper reversing position toward the lower reversing position, the wiper blade 4 moves in the same manner as in the case of rotating from the lower reversing position toward the upper reversing position. Also in this case, the wiping area of the upper area of the windshield FG can be increased.

### Effects of Embodiment

As described above, in the present embodiment, when the wiper device 1 reciprocates, the wiper blade 4 is pushed toward the upper region of the windshield FG by the operation of the link mechanism 2 (the outer end of the wiper blade 4 is shifted toward the upper region of the windshield FG). As a result, the wiping area of the upper area of the windshield FG can be increased. That is, in the wiper device 1 including only one wiper arm, the wiping area of the entire windshield FG can be increased.

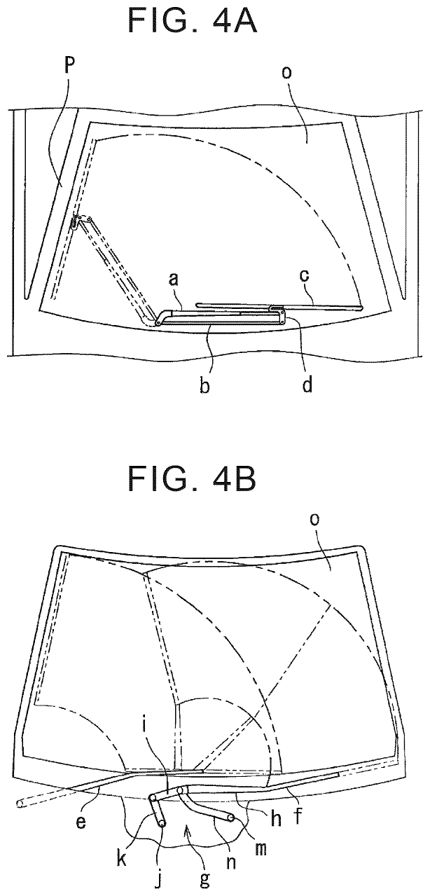

Further, in the wiper device disclosed in JP 2011-168165 A (see FIG. 4A) described above, the rotational angle of the output shaft when the wiper arm reciprocates between the lower reversing position and the upper reversing position was about 110°. On the other hand, in the present embodiment, the rotation angle of the output shaft 51 is about 150° or more. The upper limit of the rotational angle is determined by the size of the windshield FG, the position of the output shaft 51, and the like. Thus, by defining the rotation angle of the output shaft 51 as a relatively large value, it is possible to reliably perform the operation of the link mechanism 2 for enlarging the wiping area.

Further, in the wiper device disclosed in JP 2004-142499 A (see FIG. 4B) described above, when in the lower reversing position, the main lever k extends upward with respect to the pivot axis j, and the sub lever n also extends upward with respect to the driven axis m. Therefore, in the lower reversed position, the protruding amounts (upward protruding amounts) of the lever k, n and the arm head i from the lower end of the windshield o are large, and the field of view is insufficient. On the other hand, in the present embodiment, the attitude of the arm main body portion 21a in the lower reversing position is slightly inclined downward from a portion that continues to the support portion 21b to which the output shaft 51 is connected toward the wiper arm body 3 side (the right side in FIG. 1B). Further, the attitude of the arm main body portion 22a in the lower reversing position is slightly inclined downward from a portion that continues to the support portion 22b to which the sub-shaft 52 is connected toward the wiper arm body 3 side (right side in FIG. 1B). Therefore, in the lower reversed position, the protruding amounts of the respective arms 21 and 22 from the lower end of the windshield FG can be reduced, and the field of view can be sufficiently secured.

### EXPERIMENTAL EXAMPLE

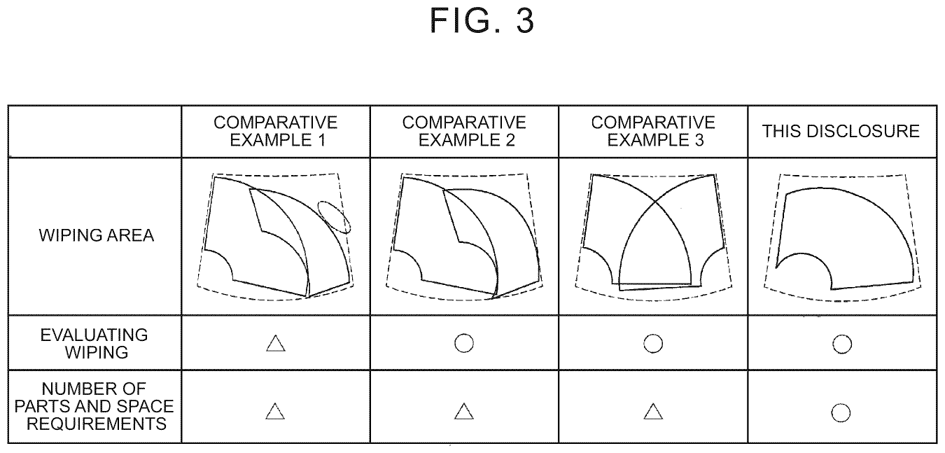

Experimental results performed to confirm the above effects will be described. In this experiment, as shown in FIG. 3, the wiper device of 3 types (Comparative Example 1 to Comparative Example 3) as a comparative example and the wiper device 1 according to the present disclosure are obtained by comparing the wiping area, the wiping evaluation, the number of parts, and the required space.

In FIG. 3, only the outer edge (broken line) of the windshield and the wiping area (solid line) by the wiper blade are shown for each of the wiper device of Comparative Example 1 to Comparative Example 3 and the wiper device 1 according to the present disclosure.

The wiper device of Comparative Example 1 is a general wiper device including two wiper arms, in which a length of a wiper blade on the driver's seat side (a wiper blade located on the left side in the drawing) is set to be long and a length of a wiper blade on the passenger seat side is set to be short. In Comparative Example 1, a large wiping residual region (a region indicated by a dashed line in the drawing) is generated in the upper portion of the front windshield on the front passenger seat side, and the wiping evaluation is low. In addition, since two wiper arms are required, the number of components is large and the space required is large.

In Comparative Example 2, two wiper arms are provided, and a link mechanism is provided at a base end portion of one of the wiper arms (a wiper arm positioned on the right side in the drawing), so that a wiping remaining area is reduced. In the comparative example 2, although the wiping evaluation is high, since two wiper arms are required and a link mechanism is required for one of the wiper arms, the number of components is large and the required space is large.

The wiper device of Comparative Example 3 is a so-called opposed type wiper device. In those of Comparative Example 3, adopting both long length as each wiper arm. Therefore, although the wiping evaluation is high, two wiper arms are required. In addition, since it is necessary to adopt both of the wiper arms having a long length, the number of parts is large and the space required is large.

In contrast to the comparative example described above, the wiper device 1 according to the present disclosure has a high wiping evaluation due to the adoption of the link mechanism 2, and since only one wiper arm is provided, the number of parts and the required space can be reduced.

### Other Embodiments

Note that the present disclosure is not limited to the above-described embodiment, and all modifications and applications encompassed within the scope of the claims and the scope of equivalents thereof are possible.

For example, in the above embodiment, the present disclosure is applied as the wiper device 1 for wiping the windshield FG. The present disclosure is not limited thereto, and may be applied to a wiper device for wiping a rear windshield.

Further, in the above embodiment, the present disclosure is applied to the wiper device 1 that is stopped at the lower reversing position in the initial state (OFF state of the wiper device 1). The present disclosure is not limited to this, and can be applied to a wiper device that is stopped at an upper reversing position in an initial state.

The present disclosure is applicable to a vehicle wiper device in which a wiping area is enlarged.

What is claimed is:

1. A vehicle wiper device comprising a wiper arm rotatably supported by a vehicle body and a wiper blade supported by the wiper arm, wherein:
the wiper arm includes a link mechanism with four nodes, a fulcrum located near the wiper blade in the link mechanism being located on an opposite side of the wiper blade from a position of a hinge of the wiper arm;
when the wiper blade is at a lower end of a windshield, an arm connected to a drive shaft, among arms constituting the link mechanism, is disposed below the drive shaft; and
a rotation direction of the drive shaft and a rotation direction of the wiper arm are the same direction.

2. A vehicle wiper device comprising a wiper arm rotatably supported by a vehicle body and a wiper blade provided on the wiper arm, wherein:
the wiper arm includes a link mechanism with four nodes, a fulcrum located near the wiper blade in the link mechanism being located on a power input fulcrum side in the link mechanism from a position of a hinge of the wiper arm;
when the wiper blade is at a lower end of a windshield, an arm connected to a drive shaft, among arms constituting the link mechanism, is disposed below the drive shaft; and
a rotation direction of the drive shaft and a rotation direction of the wiper arm are the same direction.

3. The vehicle wiper device according to claim 1, wherein:
the link mechanism includes a main arm extending in a direction along a vehicle width direction in a state in which the wiper blade is at the lower end of the windshield, a sub arm extending in the direction along the vehicle width direction on an upper side of the main arm, and a wiper arm head connected between the main arm and the sub arm and to which the wiper blade is connected via a wiper arm body;
the drive shaft is connected to the main arm, and the link mechanism operates such that power from the drive shaft is received by the main arm and causes the wiper blade to perform reciprocal turning operation; and
an angle between an extending direction of the main arm and an extending direction of the wiper arm head and an angle between an extending direction of the sub arm and the extending direction of the wiper arm head change as the wiper blade moves from a state in which the wiper blade is at the lower end of the windshield to a state in which the wiper blade is at a lateral end of the windshield, increasing a distance between a connecting position between the sub arm and the wiper arm head and a position of the drive shaft.

4. The vehicle wiper device according to claim 2, wherein:
the link mechanism includes a main arm extending in a direction along a vehicle width direction in a state in which the wiper blade is at the lower end of the windshield, a sub arm extending in the direction along the vehicle width direction on an upper side of the main arm, and a wiper arm head connected between the main arm and the sub arm and to which the wiper blade is connected via a wiper arm body;
the drive shaft is connected to the main arm, and the link mechanism operates such that power from the drive shaft is received by the main arm and causes the wiper blade to perform reciprocal turning operation; and
an angle between an extending direction of the main arm and an extending direction of the wiper arm head and an angle between an extending direction of the sub arm and the extending direction of the wiper arm head change as the wiper blade moves from a state in which the wiper blade is at the lower end of the windshield to a state in which the wiper blade is at a lateral end of the windshield, increasing a distance between a connecting position between the sub arm and the wiper arm head and a position of the drive shaft.

5. The vehicle wiper device according to claim 1, wherein a turning angle of the drive shaft during turning of the wiper blade from a state in which the wiper blade is at the lower end of the windshield to a state in which the wiper blade is at a lateral end of the windshield is in a predetermined range of 150° or more.

6. The vehicle wiper device according to claim 2, wherein a turning angle of the drive shaft during turning of the wiper blade from a state in which the wiper blade is at the lower end of the windshield to a state in which the wiper blade is at a lateral end of the windshield is in a predetermined range of 150° or more.
